(19) United States
(12) Patent Application Publication
(10) Pub. No.: US 2010/0089813 A1
(43) Pub. Date: Apr. 15, 2010

(54) CYLINDRICAL CARTRIDGE ASSEMBLY WITH INTERLOCKING WALL PANELS

(76) Inventors: Jean-Francois Tellier, Montreal (CA); Richard Blain, Montreal (CA); Serge Fraser, Boucherville (CA); Alain Scuvee, Granby (CA)

Correspondence Address: FAY SHARPE LLP, 1228 Euclid Avenue, 5th Floor, The Halle Building, Cleveland, OH, 44115, US

(21) Appl. No.: 12/525,173

(22) PCT Filed: Jan. 30, 2008
(86) PCT No.: PCT/CA08/00198

§ 371 Date: Dec. 4, 2009

(30) Foreign Application Priority Data
Feb. 2, 2007 (CA) 2,576,634
Feb. 5, 2007 (CA) 2,577,034

(51) Int. Cl. B01D 27/08; B01D 17/022; B01D 17/12; B01D 27/02; C02F 1/28

(52) U.S. Cl. 210/236; 210/263; 210/289

(57) ABSTRACT

A fluid (e.g. liquid) treatment cartridge assembly for holding solid (particulate) matter therein for contact with a fluid (e.g. a liquid medium). The cartridge comprises an outer cylindrical housing component, having a first cylindrical axis, and an inner tubular component disposed within the cylindrical housing component. The outer cylindrical housing component includes a plurality of wall panels which are interconnected by slider interlock means disposed and configured such that adjacent wall panels are slide interlocked thereby.

The present invention in general relates to a fluid treatment structure (i.e. a cartridge assembly) for the treatment of a fluid (e.g. a fluid medium) comprising two or more components whereby two or more of the components may be separated or isolated one from the other. The fluid (e.g. liquid) treatment structure may, in particular, be used to enclose solid matter (e.g. a particulate matter) for the treatment of a fluid. The fluid treatment structure may, for example, be used in a system or process for the treatment of a gas (such as for example air to remove particles therefrom) or a liquid (such as for example a liquid medium comprising oil and water). The fluid treatment structure may, for example, be used for the treatment of an oil/water, medium or substance (e.g. an emulsion) for the separation of oil from water, the oil/water medium (i.e. emulsion), being a liquid, medium or substance, wherein oil is the dispersed phase and water is the continuous phase (i.e. an emulsion wherein water is the continuous phase).

The fluid treatment structure will, by way of example only, be described in relation to a liquid (e.g. an emulsion).

It is to be understood herein that the term “oil” means any organic liquid which is substantially immiscible with water and which either has a specific gravity appreciably from that of water or which exhibits such difference when the specific gravity of the water is altered by a solute dissolved therein.

Oil from water separators are known and include, for example, coalescing separators (see for example Canadian patent nos. 1,093,478 and 1,167,774 and U.S. Pat. No. 4,102,785). For example one means for the separation of oil from an oil/water medium (i.e. emulsion) involves the use of a coalescing type filter or separator designed for “inside to outside flow”. For this “inside to outside flow” technique an oil/water medium (i.e. emulsion) may be passed (radially) through the body of an annular coalescent bed from “inside to outside”. As the oil/water medium passes through the coalescent bed oil droplets are coalesced and an oil phase separates from the water passing through the coalescent bed. Thus oil from water separator may comprise a cartridge assembly having an annular coalescing section to cause emulsified liquids to form readily removable oil droplets in the flow. As may be appreciated various wall elements of these known separators are liquid permeable.

It would be advantageous to have a fluid (e.g. liquid) treatment cartridge unit (e.g. housing, assembly, etc.) which may be readily assembled from various elements by exploiting relatively simple mechanical interconnection means, i.e. by means which do not necessarily require the use of an adhesive, a weld, a solder joint, etc. It would in particular be advantageous if a cartridge assembly may be built up from molded (plastics) components. It would further be advantageous if a cartridge unit could be broken down into its constituent components in order to facilitate reuse of the cartridge unit, i.e. refill of the cartridge unit. It would be advantageous to have a relatively compact separator system having at least one cartridge tower, the cartridge tower comprising at least one cartridge unit held in place by a relatively simple cartridge attachment mechanism.

### STATEMENT OF INVENTION

The present invention in a general aspect relates to a fluid (e.g. liquid) treatment cartridge assembly for holding solid material defining a fluid permeable body (e.g. a body of particulate material) therein for contact with a fluid (e.g. a liquid substance). The cartridge assembly comprises an outer cylindrical housing component, having a first cylindrical axis, and an inner tubular component disposed within the cylindrical housing component. The outer cylindrical housing component includes a plurality of wall panels which are interconnected. Each wall panel may be provided with respective wall interconnect means whereby adjacent wall panels are releasably interlocked. The wall panels may, for example, be interconnected by slider interlock means disposed and configured such that adjacent wall panels are slide interlocked thereby. The outer cylindrical housing component and the inner tubular component may each have a liquid permeable aspect over at least a portion thereof for allowing fluid (e.g. liquid) to pass therethrough; the outer cylindrical housing component and the inner tubular component may, for example, each have a foraminous aspect.

The present invention in accordance with an aspect provides a fluid (e.g. liquid) treatment cartridge assembly for holding solid material defining a fluid permeable body (e.g. a body of particulate material) for contact with a fluid (e.g. a liquid), said cartridge assembly comprising:

an outer cylindrical housing component (e.g. enclosure, casing, etc.) having a first cylindrical axis

and

an inner tubular component disposed within said cylindrical housing component,

said outer cylindrical housing component comprising a first cap element, a second cap element and a cylindrical enclosure wall element, said cylindrical enclosure wall element terminating in opposed ends, one of said opposed ends being closed off by said first cap element and the other opposed end being closed off by said second cap element,

said inner tubular component having a first end member, a second end member and a tubular wall member extending from said first end member to said second end member, said inner tubular component defining an interior channel, said tubular wall member being fluid (e.g. liquid) permeable,

and

wherein said outer cylindrical housing component and said inner tubular component define a holding chamber therebetween for holding said solid material,

wherein said first cap defines a first opening extending therethrough, the first end member of said inner tubular component being connected to said first cap element such that said first opening is in fluid (e.g. liquid) communication with said interior channel of said inner tubular component,

wherein said cylindrical enclosure wall element comprises a plurality (i.e. two or more) of interconnected wall panels, each of said wall panels extending from one said opposed end to the other said opposed end of said cylindrical enclosure wall element, at least one of said wall panels being fluid (e.g. liquid) permeable, each wall panel being provided with respective wall interconnect means whereby adjacent wall panels are releasably interlocked.

The wall interconnect means (of the wall panels) may take on any suitable (i.e. desired or necessary) form. The wall interconnect means may, for example, take on the form of slider interlock means disposed and configured such that adjacent wall panels are slide interlocked thereby, i.e. the slider interlock means may comprise a first slider interlock element and an opposed second-slider interlock element.

Thus the present invention in accordance with the cartridge assembly aspect in particular provides a fluid (e.g. liquid) treatment cartridge assembly for holding solid material defining a fluid permeable body (e.g. a body of particulate material) therein for contact with a fluid (e.g. a liquid), said cartridge assembly comprising:

an outer cylindrical housing component (e.g. enclosure, casing, etc.) having a first cylindrical axis

and

an inner tubular component disposed within said cylindrical housing component,

said outer cylindrical housing component comprising a first cap element, a second cap element and a cylindrical enclosure wall element, said cylindrical enclosure wall element terminating in opposed ends, one of said opposed ends being closed off by said first cap element and the other opposed end being closed off by said second cap element,

said inner tubular component having a first end member, a second end member and a tubular wall member extending from said first end member to said second end member, said inner tubular component defining an interior channel, said tubular wall member being fluid (e.g. liquid) permeable,

and

wherein said outer cylindrical housing component and said inner tubular component define a holding chamber therebetween for holding said solid material,

wherein said first cap element defines a first opening extending therethrough, the first end member of said inner tubular component being connected to said first cap element such that said first opening is in fluid (e.g. liquid) communication with said interior channel of said inner tubular component

wherein said cylindrical enclosure wall element comprises a plurality (i.e. two or more) of interconnected wall panels, each of said wall panels extending from one said opposed end to the other said opposed end of said cylindrical enclosure wall element, at least one of said wall panels being fluid (e.g. liquid) permeable,

wherein each wall panel is provided with a first slider interlock element (e.g. disposed parallel to said first cylindrical axis) and an opposed second slider interlock element (e.g. disposed parallel to said first cylindrical axis), said first and second slider interlock elements being disposed and configured such that adjacent wall panels are slide interlocked by respective first and second slider interlock elements.

In accordance with the present invention a fluid (e.g. liquid) treatment cartridge assembly is provided wherein the inner tubular component may have a tubular axis coterminous with said cylindrical axis and the second end of the tubular wall member second may be connected to the second cap element. More generally, however, the tubular axis and the cylindrical axis may be parallel or non-parallel one to the other. Thus, alternatively, for example, as desired or necessary, the tubular axis and the cylindrical axis may be space apart and may be parallel or non-parallel one to the other. The disposition of the tubular axis and the cylindrical axis is of course to be selected keeping in mind the nature of the cartridge assembly, i.e. a fluid treatment cartridge assembly.

In accordance with the present invention a fluid (e.g. liquid) treatment cartridge assembly is provided wherein the second cap element may define a second opening extending therethrough, the second end member of the inner tubular component being connected to the second cap element such that the interior channel of the inner tubular component is in fluid (e.g. liquid) communication with the second opening.

Thus as may be appreciated from the above, in accordance with the present invention a fluid (e.g. liquid) treatment cartridge assembly is provided wherein the first and the second cap elements are each connected to the cylindrical enclosure wall element, i.e. by respective connection means. Furthermore the first cap element, (and where desired or necessary, the second cap element) is (are) also connected to the inner tubular component, i.e. again by respective connection means. The respective connection means may take on any desired or necessary form and may, for example, be releasable connection means. The first end cap and the second end cap may for example be each connected to the inner tubular component by respective press fit type connection means (see below), screw thread type connection means, key lock type connection means (i.e. having male and female interlock elements) etc.

In accordance with the present invention a fluid (e.g. liquid) treatment cartridge assembly is provided wherein each of the opposed ends of the cylindrical enclosure wall element may comprise a first lock component and the first and second cap elements each may comprise a respective second lock component. Each first lock component and a respective second lock component may be configured such that the first and second cap elements are interlocked (e.g. releasably interlocked) thereby to a respective opposed end of the cylindrical enclosure wall element. Such interlocking of the cap elements and the enclosure wall element may take on any desired or necessary form provided that separation of the elements is inhibited, e.g. the interlocking means inhibits relative axial displacement of the cap elements relative to the cylindrical enclosure wall element; the interlocking means may for example be a screw thread type connection means, key lock type connection means, etc.

In particular in accordance with the present invention a fluid (e.g. liquid) treatment cartridge assembly is provided wherein each of the opposed ends of the cylindrical enclosure wall element may comprise a first snap lock component and the first and second cap elements each may comprise a respective second snap lock component. Each first snap lock component and a respective second snap lock component may be configured such that the first and second cap elements may be interlocked thereby to a respective opposed end of the cylindrical enclosure wall element.

In particular, in accordance with the present invention a fluid (e.g. liquid) treatment cartridge assembly may be provided wherein each of the second snap lock components may comprise a plurality of respective resilient snap lock male elements and each of the first snap lock components may comprise a plurality of lock sockets for receiving a respective resilient snap lock male element; the male elements may be biased in any manner so as to tend to be in a lock configuration or position. The cap and wall elements may, furthermore, as desired or necessary be releasably interlocked. Thus the lock sockets and resilient snap lock male elements may be configured such that the male elements may be manually displaced (e.g. pushed back against their lock biasing action) such that the male elements may be cleared of the lock sockets such that the cap elements may be separated from the wall element.

In accordance with the present invention a fluid (e.g. liquid) treatment cartridge assembly is provided wherein for each wall panel, one of said slider interlock elements comprises a straight side edge male projection member and the other slider interlock elements comprises a straight side edge female slot member parallel to said straight side edge male member, said straight side edge male projection member and said straight side edge female slot member being disposed and configured such that adjacent wall panels have been interconnected by sliding the straight side edge male projection member of one wall panel in the straight side edge female slot member of an adjacent wall panel.

In accordance with the present invention a fluid (e.g. liquid) treatment cartridge assembly is provided wherein each panel may be a foraminous wall panel, namely each panel may be a perforated body having (i.e. provided with a plurality of) suitable apertures for the flow of fluid (e.g. liquid) therethrough (i.e. each of the wall panels is fluid (e.g. liquid) permeable). Similarly, the tubular wall member of the inner tubular component may be a foraminous tubular wall member. Foraminous wall panels and a formainous tubular wall member are shown in the figures discussed below.

The present invention in accordance with another aspect provides a wall panel for a cylindrical enclosure wall element of a cylindrical housing comprising a pair of end cap elements, said wall panel having opposed ends disposed transverse to first and second opposed slider interlock elements, said first slider interlock element being disposed parallel to said opposed second slider interlock element, said first and second slider interlock elements being disposed and configured such that adjacent wall panels are interlockeable by respective first and second slider interlock elements by sliding one slider interlock element in the other and wherein each of said opposed ends comprises a first lock element configured for interlocking (e.g. releasably interlocking) with a respective second lock element of a respective cap element. The wall panel, as desired or necessary, may or may not be fluid permeable.

In accordance with the present invention a wall panel is provided wherein each of said opposed ends may comprise a first snap lock element configured for interlocking with a respective second snap lock element of a respective cap element. In accordance with the present invention a wall panel is provided wherein each of the second snap lock elements may comprise a resilient snap lock male member and each of said first snap lock elements comprises a lock socket for receiving a respective resilient snap lock male member.

In accordance with the present invention a wall panel is provided wherein the wall panel may be a foraminous wall panel, namely the panel may be a perforated body having (i.e. provided with a plurality of) suitable apertures for the flow of fluid (e.g. liquid) therethrough (i.e. the wall panel is fluid (e.g. liquid) permeable).

The present invention additionally provides a cylindrical enclosure wall comprising a plurality of slide interlocked wall panels, the wall panels being as described with respect to the above mentioned wall panel aspect of the present invention.

The present invention further provides a kit for creating a cylindrical enclosure wall comprising a plurality of slide interlocked wall panels, said kit comprising a plurality of wall panels as described with respect to the above mentioned wall panel aspect of the present invention.

The present invention in accordance with a further aspect provides a kit for creating a fluid (e.g. liquid) treatment cartridge assembly for holding solid material defining a fluid permeable body (e.g. a body of particulate material) therein for contact with a fluid (e.g. a liquid), said kit comprising:

an inner tubular component for disposition within a cylindrical housing component having a first cylindrical axis, said inner tubular component having a first end member, a second end member and a tubular wall member extending from said first end member to said second end member, said inner tubular component defining an interior channel, said tubular wall member being fluid (e.g. liquid) permeable,

a plurality of interconnectable wall panels for defining a cylindrical enclosure wall element, at least one of said wall panels being fluid (e.g. liquid) permeable,

a first cap element and a second cap element, for defining, along with said cylindrical enclosure wall element, said outer cylindrical housing component,

said inner tubular component, said wall panels, said first cap element and said second cap element being configured for forming a cartridge assembly, said cartridge assembly being an assembly,

wherein said cylindrical enclosure wall element terminates in opposed ends, one of said opposed ends being closed off by said first cap element and the other opposed end being closed off by said second cap element,

wherein said outer cylindrical housing component and said inner tubular component define a holding chamber therebetween for holding said solid material,

wherein said first cap element defines a first opening extending therethrough, the first end member of said inner tubular component being connectable to said first cap element such that said first opening is in liquid communication with said interior channel of said inner tubular component,

wherein each of said wall panels is able to extend from one said opposed end to the other said opposed end of said cylindrical enclosure wall element,

and

wherein each wall panel is provided with a first slider interlock element (e.g. disposed parallel to said cylindrical axis) and an opposed second slider interlock element (e.g. disposed parallel to said cylindrical axis), said first and second slider interlock elements being disposed and configured such that adjacent wall panels are slide interlockable by respective first and second slider interlock elements.

In accordance with the present invention a kit is provided wherein for each of said wall panels, one of said slider interlock elements comprises a straight side edge male projection member and the other slider interlock element comprises a straight side edge female slot member parallel to said straight side edge male projection member, said straight side edge male projection member and said straight side edge female slot member being disposed and configured such that the straight side edge male projection member of one wall panel is able to slide in the straight side edge female slot member of an adjacent wall panel so at to be able thereby to slide interconnect the adjacent panels.

In accordance with the present invention a kit may comprise foraminous wall panels as described herein, and, if present, a foraminous tubular wall member.

As a further aspect the present invention relates to a separator system for the separation of an immiscible liquid (e.g. oil) from water (e.g. an oil in water liquid medium), the system comprising at least one cartridge tower (as described herein) the cartridge tower comprising at least one cartridge assembly as described herein. A clamp type cartridge attachment means, an example of which is described herein, may be used to maintain the cartridge tower(s) in place in the separator system (e.g. so that the cartridge assembly(ies) thereof are in liquid communication with liquid medium inlet means (e.g. pipe(s), chamber(s), etc.). The clamp type cartridge attachment means may connect a cartridge tower to a suitable liquid medium input means.

Thus in accordance with the above mentioned further aspect the present invention also provides a separator system for the separation of a water immiscible liquid (e.g. oil) from a liquid medium comprising water and the water immiscible liquid (e.g. oil) wherein water is the continuous phase, the system comprising at least one cartridge tower for the separation of said water immiscible liquid from the liquid medium, the cartridge tower comprising one or more cartridge assemblies and clamp type cartridge attachment means for connecting each of said cartridge assemblies to liquid medium inlet means so that each of said cartridge assemblies are in liquid communication with said liquid medium inlet means, each of said cartridge assemblies being charged with a predetermined particulate material defining a liquid permeable coalescent body, said cartridge assembly being a cartridge assembly as defined herein, said liquid medium inlet means being in liquid communication with the interior channel the inner tubular component of said cartridge assemblies. The clamp type cartridge attachment means may take on any desired or necessary form and may for example take the form discussed herein below.

It is to be understood herein that the expressions “slide interlockable”, “slide interlocked” “slide interconnect” or the like in relation to “slider interlock means”, “first and second slider interlock elements”, and the like, refer to an interconnection between the wall panels whereby displacement of the wall panels is inhibited in a non-sliding direction. In other words, these expressions refer, for example, to an interconnection between the wall panels whereby displacement of the wall panels transverse to the cylindrical axis (or, for example, transverse to the parallel wall interlock elements themselves, if the wall panels are provided with parallel interlock elements) is inhibited by the slider interlock means, the slider interlock elements, or the like; on the other hand, unless otherwise inhibited, displacement, for example, parallel to the cylindrical axis (or if present, parallel to parallel interlock elements) is not inhibited by the slider interlock means, the slide interlock elements or the like.

It is also to be understood herein that the expressions “fluid permeable”, “ liquid permeable”, “gas permeable”, or the like as they relate to a body, a bed, a wall member, a wall panel or the like, characterizes the body, the bed, the wall member, the wall panel or the like, as having openings of any desired, necessary or sufficient, number, configuration, size, etc. for allowing the desired or necessary passage therethrough of a fluid (e.g. the liquid components of an emulsion such as a water component and an oil component of a water/oil emulsion); e.g. a fluid permeable wall element is a wall element interrupted with openings sufficient to allow the desired passage therethrough of a fluid (i.e. a liquid such as a water/oil emulsion). The openings are of course also to be sized keeping in mind the nature of the solid material defining the fluid permeable body or bed which may be held for example by a cartridge assembly. If the cartridge assembly is to hold particulate material, the nature, disposition and number of (wall) openings may be determined (i.e. empirically) by keeping in mind that any openings should inhibit passage therethrough of the particulate material making up the fluid peremeable bed or body. i.e. wall panel openings may be configured such that the wall panels may maintain the desired integrity of the bed or body.

In accordance with the present invention the outer cylindrical housing component and the inner tubular component may for example define an annular holding chamber for holding solid material defining a fluid permeable body or bed. The annular holding chamber may, for example, be charged or filed with a desired particulate material. Thus, for example, the cartridge assembly may be charged with a coalescing medium for causing a liquid component of a liquid mixture (e.g. emulsion) to be separated or removed from the mixture by being coalesced into droplets. The particulate material may, for example, be of a (coalescent particulate) material of the type(s) described in Canadian patent application no. 2,511,884; for an additional description of possible types of materials please see Canadian patent nos. 2,085,951 and 2,421,076 as well as U.S. Pat. No. 5,239,040. The entire contents of each of these Canadian and U.S. patent documents are incorporated herein by reference.

It is thus also to be understood herein that the expressions “coalescent bed”, “coalescent body” or the like refer to a coalescent bed, body or the like which is able to facilitate the coalescence, for example, of water immiscible liquid droplets (e.g. oil droplets) from an emulsion comprising the water immiscible liquid (e.g. oil) in water (i.e. water being the continuous phase).

In the drawings which illustrate an example(s) embodiment(s) of the invention:

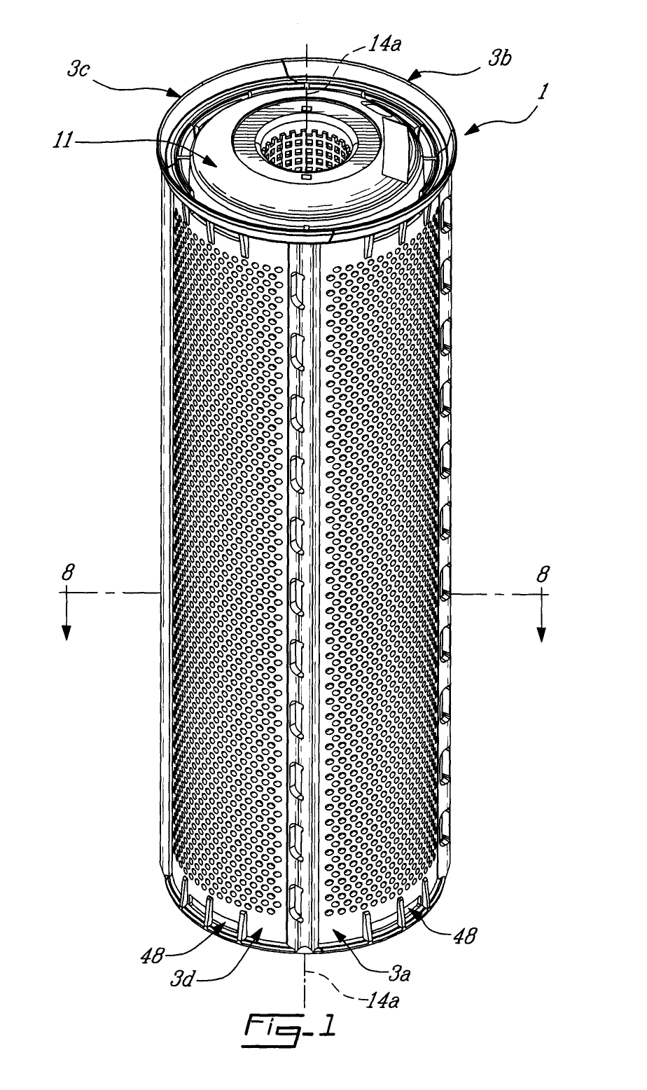

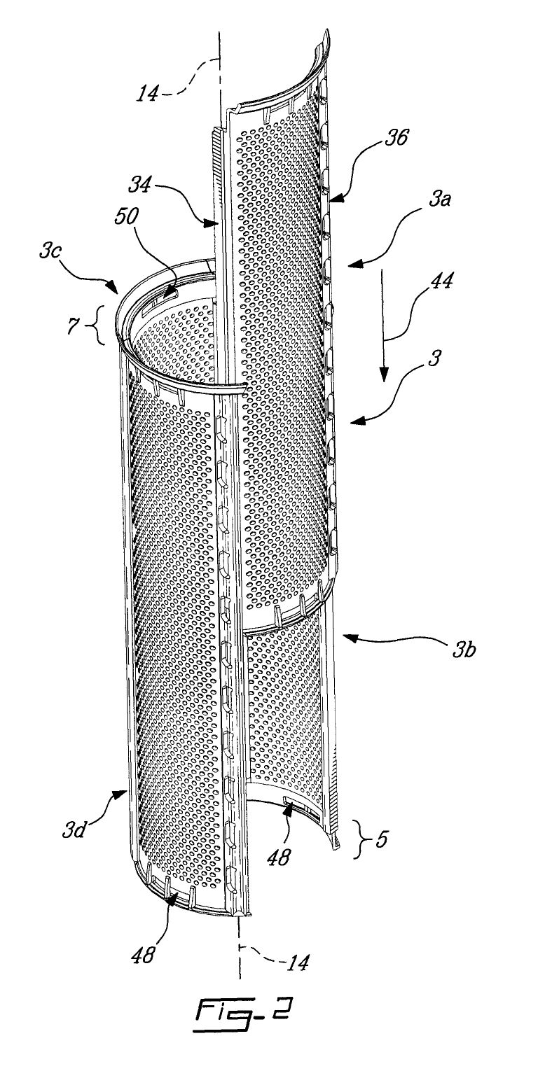

FIG. 1 is a perspective view from above of an example embodiment of a cartridge assembly in accordance with the present invention;

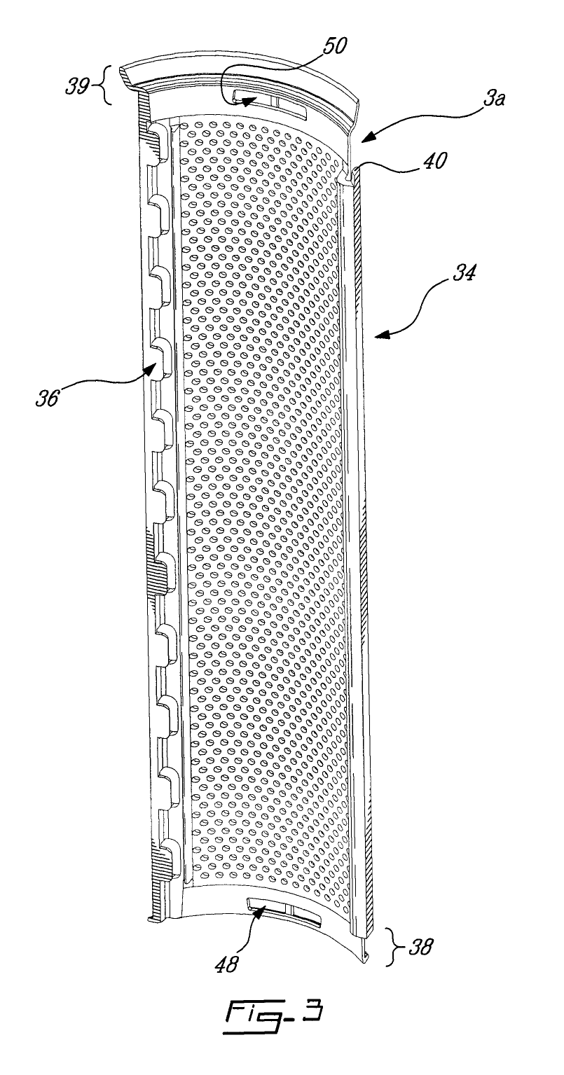

FIG. 2 is a perspective view from above of the cylindrical enclosure wall element of the outer cylindrical housing component of the cartridge assembly of FIG. 1;

FIG. 3 is a perspective view of the interior side of a wall panel of the outer cylindrical housing component of FIG. 2;

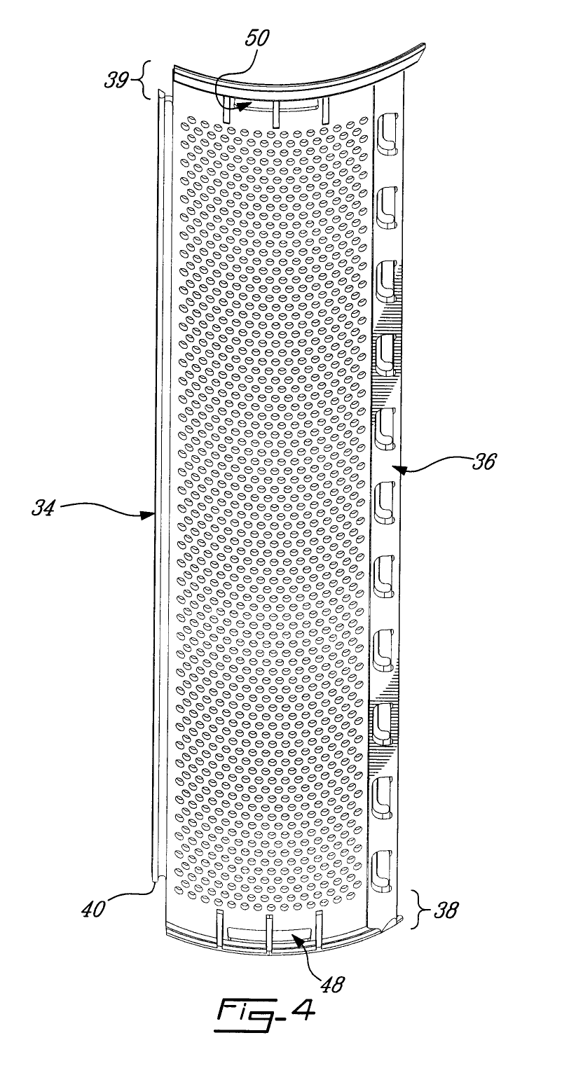

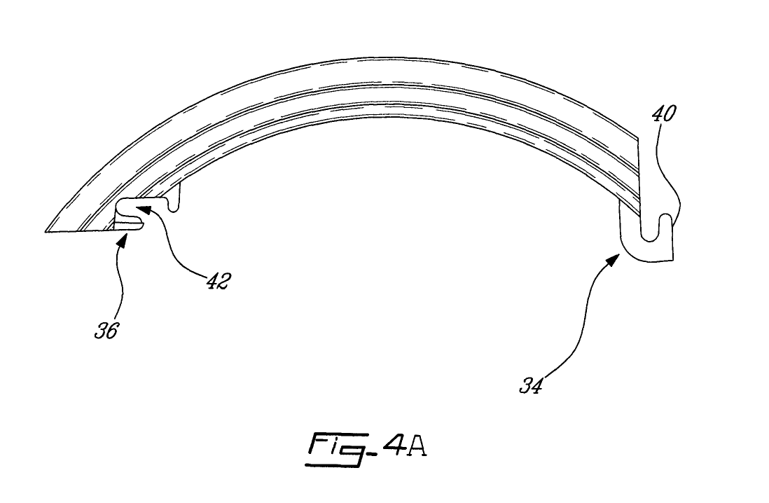

FIG. 4 is a perspective view of the exterior side of the wall panel of FIG. 3;

FIG. 4A is a top view of the wall panel of FIG. 3;

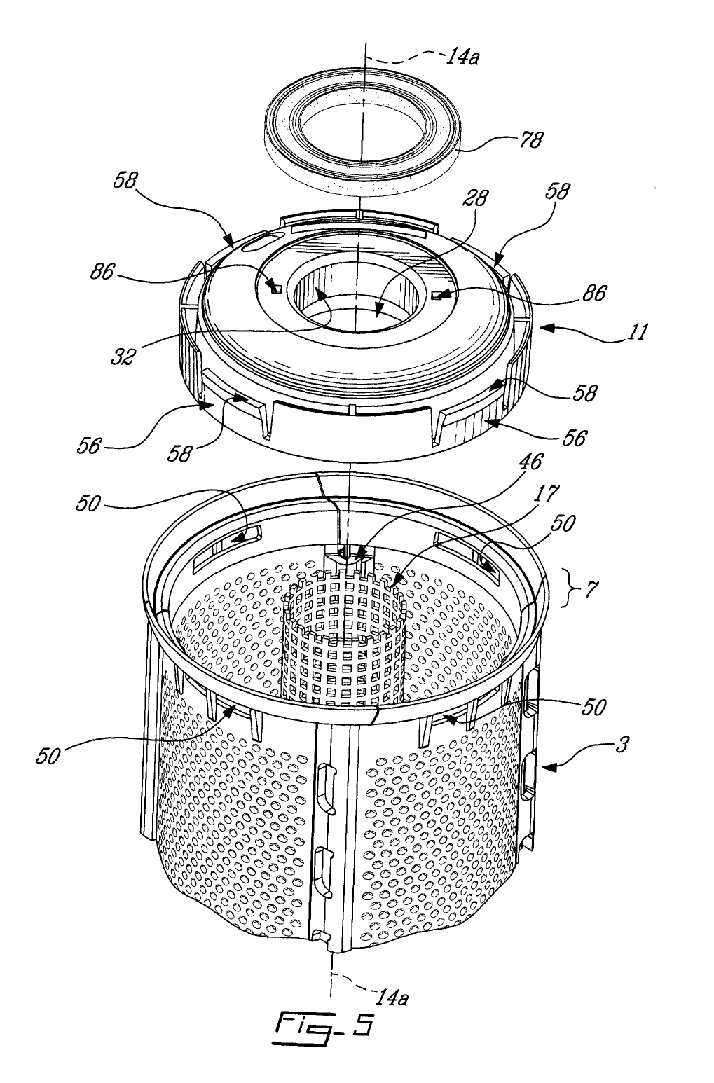

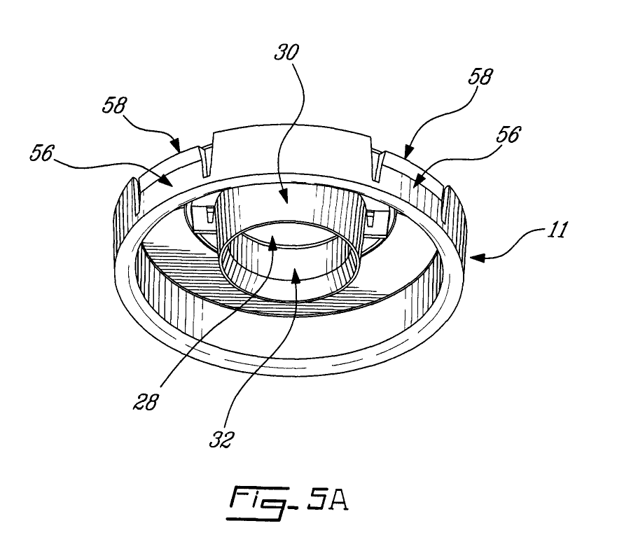

FIG. 5 is a perspective exploded view of the top end of the cartridge of FIG. 1 including a gasket member;

FIG. 5A is a perspective view from below of the (second) cap element shown in FIG. 5;

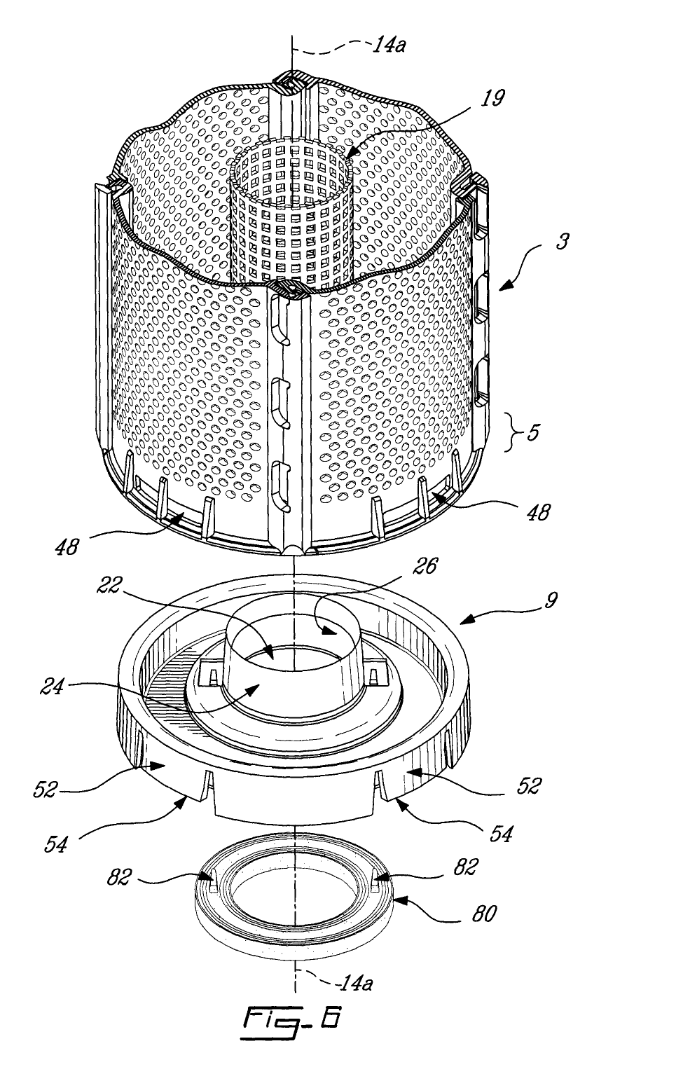

FIG. 6 is a perspective exploded view of the lower end of the cartridge assembly of FIG. 1 including a gasket member;

FIG. 6A is a perspective view from below of the (first) cap element shown in FIG. 5;

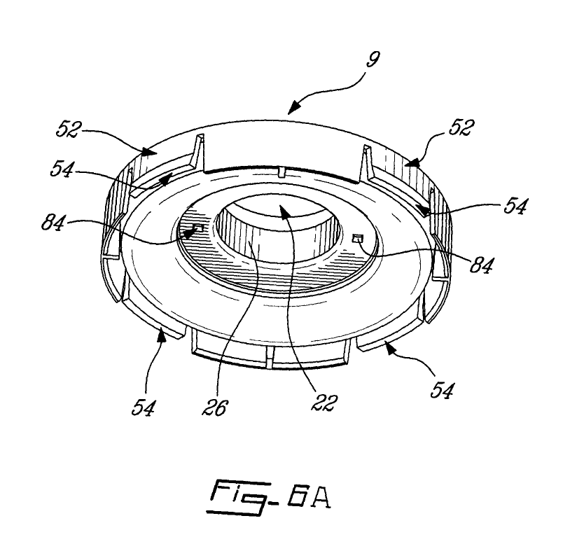

FIG. 7 is a side view of the cartridge assembly of FIG. 1, including gasket members, and wherein two of the four wall panels making up the outer cylindrical housing component are removed and the first and second cap elements, the inner tubular component and the gasket members shown in cross-section;

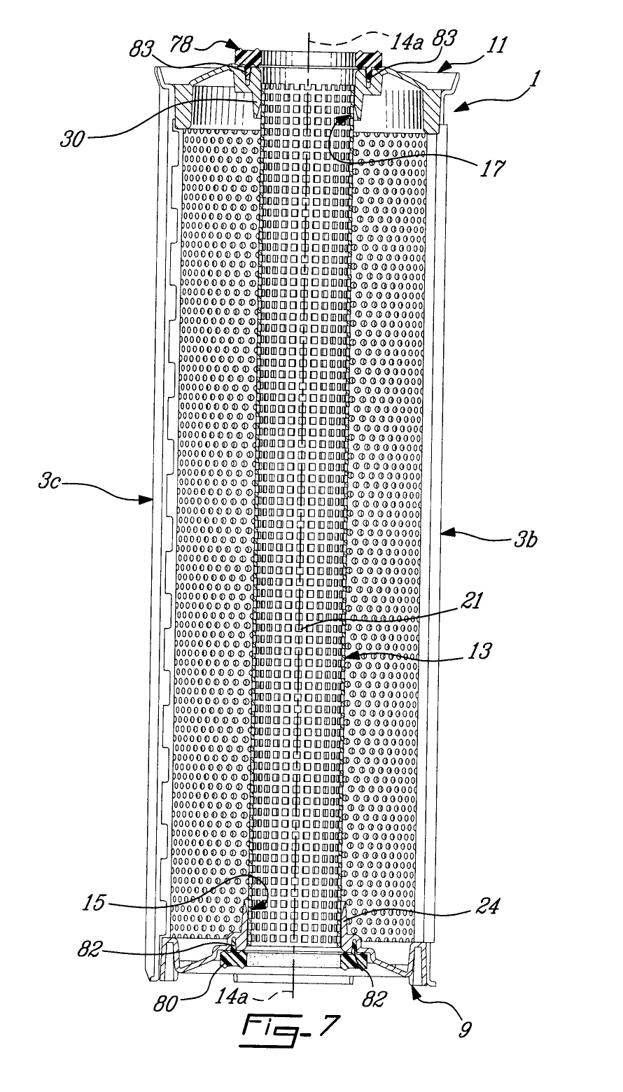

FIG. 8 is a cross section along 8-8 of the cartridge assembly shown in FIG. 1;

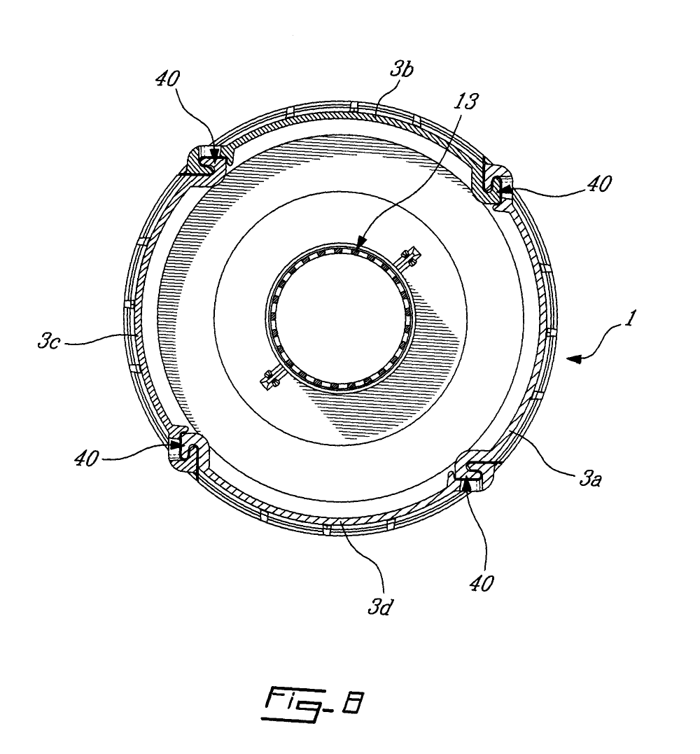

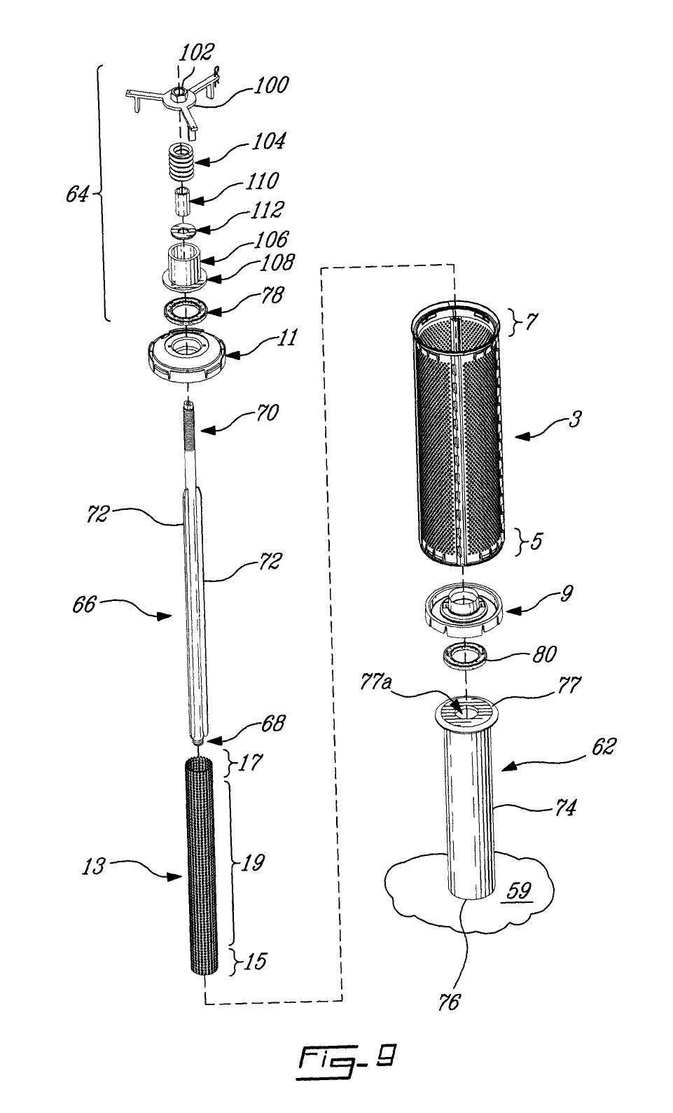

FIG. 9 is an exploded perspective view from above of the cartridge assembly of FIG. 1 associated with elements of an example clamp type cartridge attachment mechanism for connection of the cartridge assembly in a (coalescence type) liquid separator system;

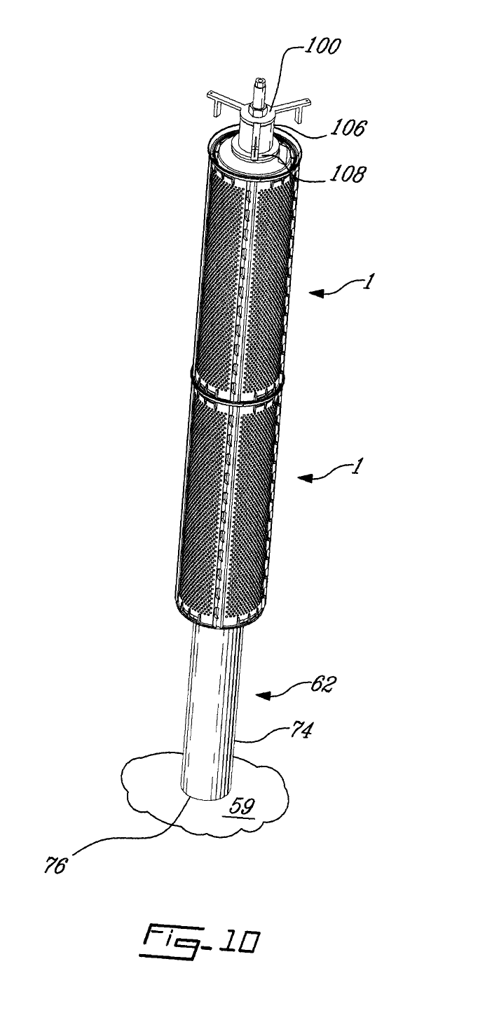

FIG. 10 is a perspective view from above of a cartridge tower comprising two cartridges of FIG. 1 nested together with the elements of the example clamp type cartridge attachment mechanism of FIG. 9;

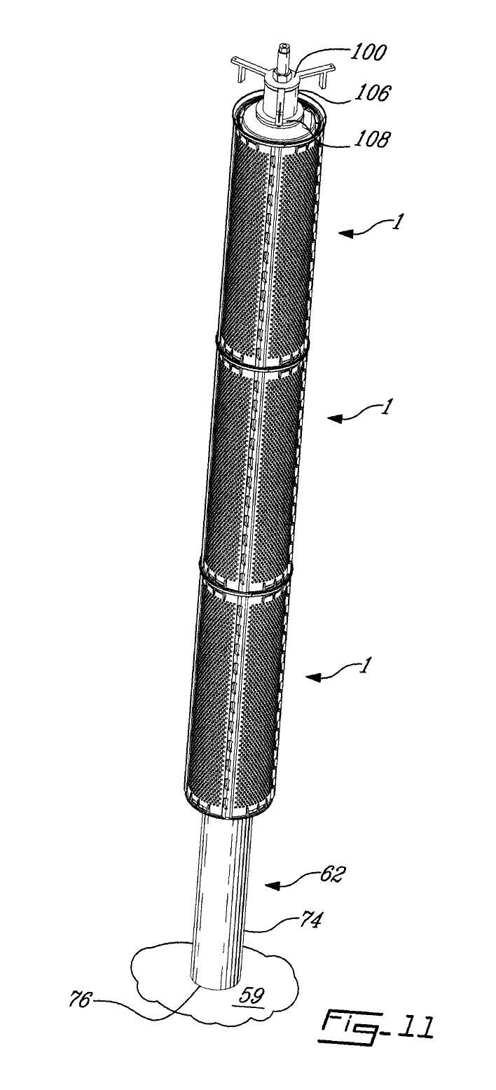

FIG. 11 is a perspective view from above of a cartridge tower comprising three cartridges of FIG. 1 nested together with the elements of the example clamp type cartridge attachment mechanism of FIG. 9, the cartridge assemblies being charged with particulate material;

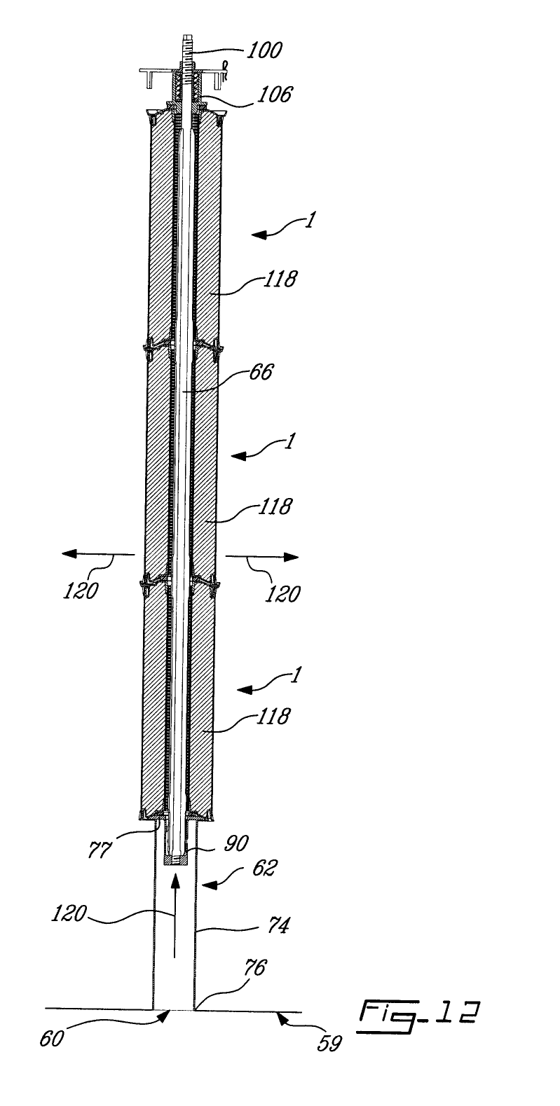

FIG. 12 is a cross sectional side view of the cartridge tower of FIG. 11;

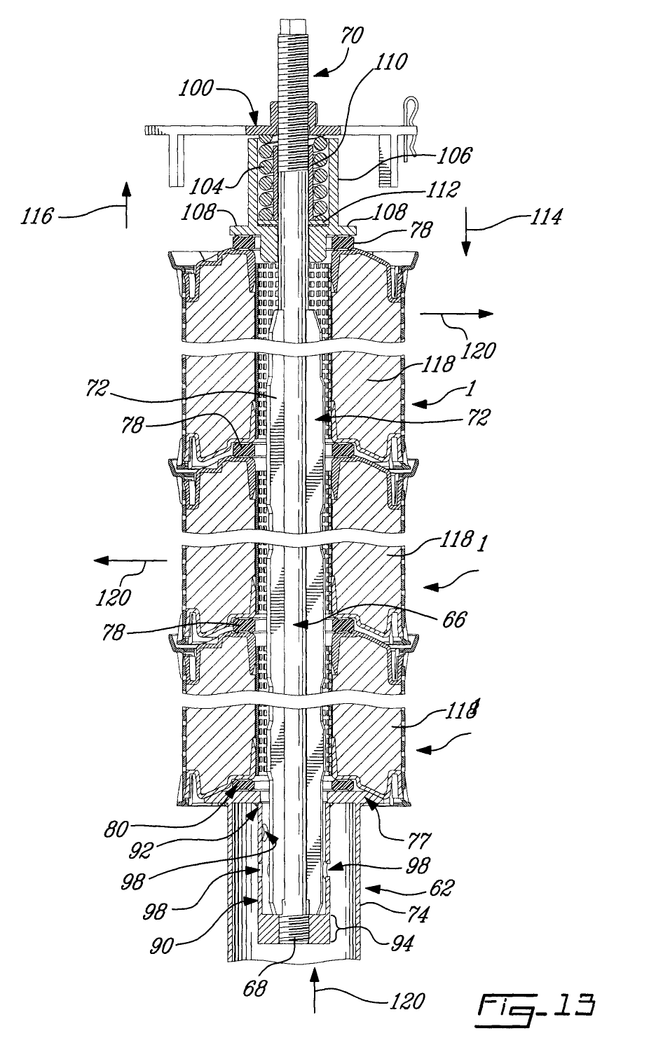

FIG. 13 is an enlarged view of the cartridge tower of FIG. 12; and

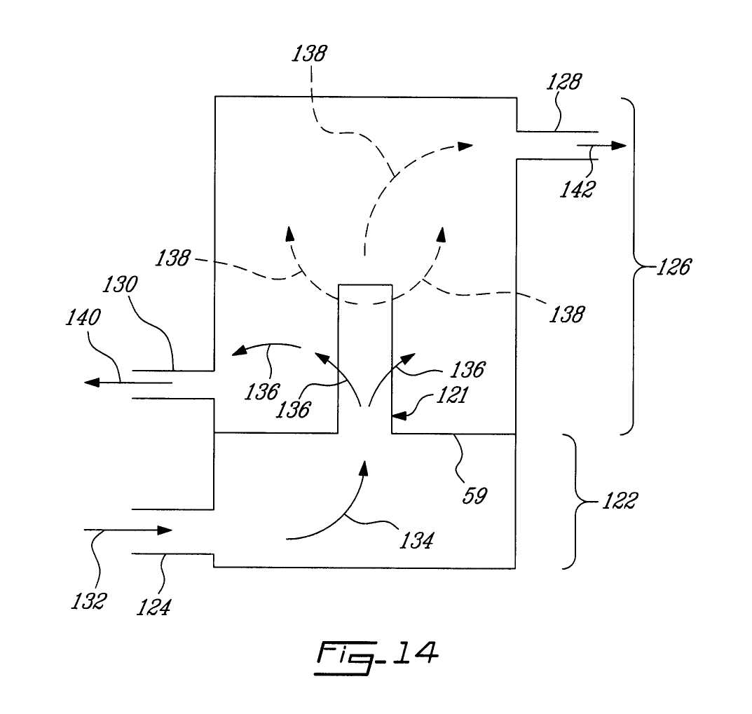

FIG. 14 illustrates in schematic fashion the association of a cartridge of the present invention in a separator system for the separation of an (immiscible) oil from water.

In each of the figures the same reference numerals are used to identify the same elements, components, members, etc.

FIG. 1 illustrates an example embodiment, in accordance with the present invention, of a liquid treatment cartridge assembly for holding particulate matter therein for contact with a liquid medium. The exemplified cartridge assembly may as discussed herein be incorporated into a liquid separator system designed for “inside to outside flow” of liquid (i.e. liquid medium such as a water/oil emulsion).

The example cartridge illustrated in FIG. 1 comprises an outer cylindrical housing component 1 (e.g. enclosure, casing, etc.). Referring also to FIG. 2 the outer housing component 1 comprises a cylindrical enclosure wall element 3 which is made up of four slide interconnected (i.e. slide interlocked) wall panels 3a, 3b, 3c and 3d. The wall panels are identical and each have the configuration as set forth in more detail in FIGS. 3, 4 and 4A. Although the cylindrical enclosure wall element is shown as comprising four (4) wall panels, the cylindrical enclosure wall element could as desired or necessary be defined by more than four panels (e.g. 6, 8 or 9 wall panels, etc.) or less than four panels (e.g. 3 or two wall panels).

The cylindrical enclosure wall element terminates in opposed ends which are respectively generally indicated by the reference numerals 5 and 7.

Referring to FIGS. 1, 5, 6 and 7, the outer cylindrical housing component 1 also comprises a first end cap element 9 and a second end cap element 11. The opposed end 5 of the cylindrical enclosure wall element 3 is closed off by the first cap element 9 and the other opposed end 7 of the cylindrical enclosure wall element 3 is closed off by the second cap element 11.

The illustrated example cartridge assembly of FIG. 1 also comprises an inner tubular component 13 disposed within the cylindrical housing component 1 (see FIGS. 5, 6, 7, 8 and 9). The outer cylindrical housing component 1 has a first cylindrical axis (reference numeral 14 in FIG. 2) which is coterminous or coincident with the tubular axis of the inner tubular component 13. In other words the outer cylindrical housing component 1 and the inner tubular component 13 share a common (longitudinal) axis; this common axis is designated by the reference numeral 14a in FIGS. 1, 5 6, 7 and 8.

The inner tubular component 13 (see FIG. 9) has a first end member 15, a second end member 17 and a tubular wall member 19 extending from the first end member 15 to the second end member 17. The inner tubular component 13 defines an interior channel, i.e. an interior channel which extends from the first end member 15 through the tubular wall member 19 to the second end member 17. The inner tubular component 13 is further provided with a plurality of wall perforations along its entire length and circumference (see FIGS. 5, 6 and 7) such that when it is installed in place within the cylindrical housing component 1 the tubular wall member 3 thereof is liquid permeable for allowing the passage of liquid medium therethrough. One such perforation is designated 21 in FIG. 7. The example inner tubular component 13 is shown as having a circular cross sectional aspect. However, the inner tubular component, keeping in mind its purpose to provide a part of a liquid medium path from inside to outside of the cartridge assembly, may as desired or necessary have other types of cross sectional aspects, e.g. an oval aspect, a triangular aspect, a polygonal aspect, a rectangular aspect, etc.; the wall panels will of course take on their own particular cross sectional aspects corresponding to the desired cross sectional aspect of the inner tubular component. The example inner tubular component 13 is also shown as having an essentially continuous (circular) wall (see FIGS. 5 and 6); alternatively, as in the case of the cylindrical enclosure wall element 3, the inner tubular component 13 may as desired or necessary be defined by a plurality of its own wall panels which may have attributes analogous to those as described herein with respect to the wall panels 3a, 3b, 3c and 3d of the cylindrical enclosure wall element 3.

Referring to FIGS. 6, 6A and 7 the first end cap element 9 includes a first opening 22 extending therethrough. The first end cap element 9 thus includes a wall member 24 which defines the opening 22. The wall member 24 has an interior surface 26 configured and sized to engage the first end member 15 of the inner tubular component 13. In this way, as may be seen, the first end member 15 of the inner tubular component 13 is connected to the first end cap element 9 such that the first opening 22 thereof is in liquid communication with the interior channel of the inner tubular component 13 (i.e. with the interior of the tubular wall member 19).

Additionally, for the embodiment shown (see FIGS. 5, 5A and 7), the second end cap element 11 also has a second opening 28 extending therethrough. The second end cap element 11 also includes a wall member 30 which defines the opening 28. The wall member 30 has an interior surface 32 configured and sized to engage the second end member 17 of the inner tubular component 13. In this way, the second end member 17 of the inner tubular component 13 is similarly connected to the second cap element 11 such that the interior channel of the inner tubular component 13 is in liquid communication with the second opening 28; i.e. the interior of the tubular wall member 19 is in liquid communication with the second opening 28.

As an alternative connection mechanism the wall members 24 and 30 could be sized (i.e. reduced in size so that exterior surfaces thereof are able) to engage the interior surface of a respective first or second end member of the inner tubular component 13.

As may be appreciated from FIG. 7, the inner tubular component 13 is shown as extending from the lower first end cap element 9 to the other upper second end cap element 11 in the figures so as to provide liquid communication from one end cap element opening (22) to the other end cap element opening (28). As an alternative, if so desired or necessary, the second opening 28 may be dispensed with. In this case, for example, the distal end of the wall member 30 may be closed off and the proximal end of the wall member 30 still having the above mentioned interior surface 32 may still be able to engage the second end member 17 (as shown in FIG. 7) such that the inner tubular component 13 may simply be connected to the second end cap element 11 to give support to the inner tubular component 13. Additionally, if so desired the inner tubular component 13 may terminate with a second end member which is disposed within the cylindrical enclosure wall element 3 but does not engage the second end cap element 11, i.e. if desired an end of the inner tubular component 13 may terminate within the cylindrical enclosure wall element and be closed off by its own end cap member.

As may be appreciated from FIGS. 5, 6, 7 and 8, the outer cylindrical housing component 1 and the inner tubular component 13 define an annular solid (e.g. particulate) matter holding chamber. For the purposes of illustration herein, the solid (e.g. particulate) matter is not indicated in any of the figures except for FIGS. 12 and 13. However, in practice, one of the end cap elements 9 or 11 would be installed to the assembled cylindrical enclosure wall element 3 (as discussed herein) so as to close off a respective opposed end 5 or 7 thereof. The inner tubular component 13 would then be inserted into the opening 22 (or 28) of the installed end cap element such that the wall member 24 (or 30) engages a respective end member 15 or 17 of the inner tubular component 13 as seen for example on FIG. 7. Thereafter the annular holding chamber would be (completely) filled (via the remaining unobstructed other opposed end) with the desired (amount and type of) solid material (e,.g. a desired particulate coalescence inducing material). Once the annular holding chamber would be filled as desired, the remaining cap element 9 or 11 would be installed or engaged (as discussed herein) with respect to the remaining opposed end of the cylindrical enclosure wall element 3 as well as with respect to the other end member of the inner tubular component 13.

Referring back to FIGS. 2, 3, 4 and 4A the cylindrical enclosure wall element 3 comprises a plurality of identical interconnected wall panels, i.e. in this case four wall panels 3a, 3b, 3c and 3d. Each of the wall panels 3a, 3b, 3c and 3d extends from one of the opposed ends (e.g. 5) of the cylindrical enclosure wall element 3 to the other the opposed end (e.g. 7) of the cylindrical enclosure wall element 3. Each of the wall panels 3a, 3b, 3c and 3d is also liquid permeable, i.e. each wall panel is provided with a plurality of apertures, the number, shape and size of the apertures being chosen on the basis of the type of particulate material to be held by the cartridge and may be determined empirically on a case by case basis. As may be seen (see FIG. 4A in particular) the wall panels each have an arcuate (i.e. bent, curved or bowed) cross sectional aspect given that the example cylindrical enclosure wall element 3 has a circular cross sectional aspect. The cylindrical enclosure wall element 3, as in the case of the inner tubular component 13, may as desired have other cross sectional aspects (e.g. square, triangular, polygonal, etc.) such that the wall panel elements will have cross sections corresponding to these other aspects.

Referring in particular to FIGS. 3, 4 and 4A which show wall panel 3a, each wall panel 3a, 3b, 3c and 3d is provided with a first slider interlock element (indicated generally by the reference numeral no. 34) disposed parallel to an opposed second slider interlock element (indicated generally by the reference numeral no. 36). Each wall panel 3a, 3b, 3c and 3d has opposed ends 38 and 39 disposed transverse to the first and second opposed slider interlock elements (34 and 36). As shall be discussed in more detail below, the first and second slider interlock elements (34 and 36) are disposed and configured such that adjacent wall panels are slide interlockeable by their respective first and second slider interlock elements by sliding one slider interlock element in the other. As mentioned above, it is to be understood herein that the word “slide interlockable” or the like in relation to the first and second slider interlock elements refers to an interconnection between the wall panels whereby displacement of the so interlocked wall panels transverse to the cylindrical axis (or to the parallel interlock elements themselves) is inhibited by the interlock elements.

As may be seen from FIG. 2, the first and second slider interlock elements (34 and 36) of each wall panel 3a, 3b, 3c and 3d are disposed and configured such that adjacent wall panels of the assembled cylindrical enclosure wall element 3 are interlocked by respective first and second slider interlock elements. As also may be seen from FIG. 2, the slider interlock elements (34 and 36) of each panel are so disposed that once the wall panels are assembled to form the cylindrical enclosure wall element, the slider interlock elements are disposed parallel to the cylindrical axis 14.

Referring in particular to FIGS. 3, 4, 4A and 8, each of the first slider interlock elements comprises a first straight side edge male projection member 40 and each of the second slider interlock elements comprises a corresponding second straight side edge female slot member 42 (see FIG. 4A) parallel to the first straight side edge male projection member 40. As may be seen, the first straight side edge member 40 and the second straight side edge member 42 are disposed and configured such that adjacent wall panels are able to be interconnected by sliding the straight male projection member 40 of one wall panel into the straight female slot member 42 of an adjacent wall panel (see for example FIG. 2 which shows the last of the four wall panels (3a) being slide in the direction of the arrow 44 to complete the cylindrical enclosure wall element 3). Each of the interconnected male projection members 40 and female slot members 42 terminate in a seat 46 for engagement with a respective end cap element (see FIG. 5); as may be appreciated there are four such seats at each end 5 and 7.

As may be understood from FIG. 2 the (slider) interconnection between the wall panels is such that displacement of the wall panels transverse to the cylindrical axis 14 is inhibited by the interlock elements. On the other hand, until at least one of the end cap elements 9 or 11 is installed, as explained below, the wall panels 3a, 3b, 3c and 3d may be disengaged by sliding them (apart) in a direction parallel to the cylindrical axis. However, once at least one of the end cap elements 9 or 11 is installed, even displacement of the wall panels 3a, 3b, 3c and 3d parallel to the cylindrical axis 14 is inhibited by the installed end cap element 9 or 11.

The cartridge assembly 1 shown in the drawings is provided with an example (quick) snap interlock means for interlocking the end cap elements 9 and 11 with the cylindrical enclosure wall element 3.

Thus, as may be seen from FIGS. 1 and 7, as well as FIGS. 5, 5A, 6, and 6A, the end of the cylindrical enclosure wall element 3 is provided with a first snap lock component which comprises four female snap lock elements in the form four lock sockets (e.g. openings) which are designated with the common reference numeral 48. Likewise, the other opposed end of the cylindrical enclosure wall element 3 is also provided with a first snap lock component which also comprises four lock sockets (e.g. openings) which are designated with their own common reference numeral 50. As may be seen from FIGS. 3 and 4 each wall panel 3a, 3b, 3c and 3d contributes one (complete) lock socket 48 and one (complete) lock socket 50. As an alternative, each wall panel may have two lower opposed half-sockets and two upper half sockets which each open up on a slider side of the wall panel; such half sockets may be disposed such that when adjacent wall panels are interlocked each half socket is aligned with a respective half socket of an adjacent wall panel so as to define a complete lock socket.

Still referring to FIGS. 1 and 7, as well as FIGS. 5, 5A, 6, and 6A, the first and second end cap elements 9 and 11 each comprise a respective second snap lock component. The second snap lock component of the first end cap element 9 comprises four respective snap lock elements in the form of four resilient snap lock male elements (designated by a common reference number 52) each of which has a lock tip (designated by a common reference number 54)—see FIGS. 6 and 6A. Likewise, the second snap lock component of the second end cap element also comprises four respective snap lock elements in the form of four resilient snap lock male elements (designated by a common reference number 56) each of which also has a lock tip (designated by a common reference number 58)—see FIGS. 5 and 5A. The lock tips 54 and 58 are shown in FIGS. 5, 5A, 6, and 6A in a bias lock position. The example end cap elements 9 and 11 are of a (suitable) material (e.g. plastics material) whereby the male elements 52 and 56 are resiliently connected to the main body of a respective end cap element 9 or 11. As a result the lock tips (54 and 58) of the male elements (52 and 56) may be displaced (i.e. pushed) inwardly (i.e. radially) from the bias lock position (e.g. shown in FIG. 5A or 6A) to an inner unlock position (not shown); once the inward force is removed the lock tips of the male element will tend to spring back to the bias lock position.

Thus, as may be appreciated, the lock sockets (48 and 50) and respective male elements (52 and 56) are configured and disposed so that each lock socket 48 (or 50) is able to snap receive a respective male element 52 (or 56) (i.e. at least the lock tip 54 (or 56) thereof) so as to interlock the end cap elements 9 and 11 to the cylindrical enclosure wall element 3. More particularly, referring for example to FIG. 6 the first end cap element 9 is disposed with respect to the end 5 of the cylindrical enclosure wall element 3 such that each of the lock tips 54 are aligned below a respective lock socket 48. The first end cap element 9 is then pushed axially into the opening of the end 5 of the cylindrical enclosure wall element 3 so that the inner surface of the cylindrical enclosure wall element 3 pushes the lock tips 54 inwardly. As the first end cap element 9 continues to axially proceed into the opening of the end 5 the lock tips 54 eventually arrive at a respective lock socket 48 and the male elements 52 spring (i.e. snap) outwardly so that the lock tips 54 register in respective lock sockets 48. Once so interlocked, the interlock elements inhibit backward removal of the first end cap element 9 from the end 5 of the cylindrical enclosure wall element 3. On the other hand, further axial movement into the cylindrical enclosure wall element 3 is inhibited by the four seats 46 (mentioned above—see FIG. 5). The (reverse) removal of the first end cap element 9 from the cylindrical enclosure wall element 3 may be effected by (e.g. manually) pushing the lock tips 54 inwardly (e.g. from the exterior side of the lock sockets inwardly) so as to be clear of the lock sockets 48 and then applying an axial rearward displacement force to remove the first end cap element 9 from the end 5 of the cylindrical enclosure wall element 3.

Referring to FIG. 5, the second end cap element 11 is attachable to the other end 7 of the cylindrical enclosure wall element 3 in the same fashion as described above with respect to the attachment of the first end cap element 9.

It is of course to be appreciated that once the first end cap element 9 is attached to the end 5 of the cylindrical enclosure wall element 3, the inner tubular component 13 may be inserted into the cylindrical enclosure wall element 3 so that the first end member 15 thereof is slide into (releasable) engagement (i.e. in surface to surface abutment) with in the above mentioned opening 22 of the first end cap element 9, i.e. the first end member 15 may engage the opening 22 in a (releasable) snug but not tight press fit type engagement for facilitating manual disengagement. Again, as mentioned above, the so formed annular holding space may then be filled with the desired particulate material. Once the annular holding space is filed with the particulate material (not shown in FIGS. 1 to 8) the second end cap 11 is attached as described above; however, the attachment of the second end cap element 11 includes the alignment and sliding engagement (i.e. in surface to surface abutment) of the second end member 17 of the inner tubular component 13 with the opening 28 of the second end cap element 11; again, the second end member 17 may engage the opening 28 in a (releasable) snug but not tight press fit type engagement for facilitating manual disengagement. The particulate material may, for example, be of a (coalescent particulate) material of the type(s) described in Canadian patent application no. 2511884 mentioned above.

Referring to FIGS. 9 to 13 a cartridge assembly of FIGS. 1 to 8, charged with suitable particulate material, may be incorporated into a coalescent type separator system. The system may comprise a liquid inlet chamber (not shown) and a liquid separator chamber (not shown) which share a common wall 59. The liquid inlet chamber has a liquid inlet (not shown) for input of liquid medium; the liquid separator chamber has a first lower liquid outlet (not shown) for discharge of a liquid (e.g. water) and a second upper liquid outlet (not shown) for discharge of a liquid (e.g. lighter water immiscible oil). The common wall 59 between the liquid inlet chamber and the liquid separator chamber has an opening (i.e. common wall opening 60) for liquid communication between the inlet chamber and the separator chamber (see FIG. 12).

The separator system may comprise a clamp type cartridge attachment means or mechanism, as shown, which includes a cartridge support anchor component and a cartridge attachment component respective generally, indicated by the reference numerals 62 and 64. The clamp type cartridge attachment mechanism also includes an interconnection shaft member 66 whereby one or more cartridge assemblies (see FIGS. 10 and 11) may be maintained in place under compression between the cartridge support anchor component 62 and the cartridge attachment component 64.

The interconnection shaft member 66 has two externally threaded opposed ends 68 and 70. The interconnection shaft member 66 also has three equally spaced baffle or wing members 72 which extend radially outwardly from the shaft body of the interconnection shaft member 66. The baffle members 72 also extend longitudinally parallel to the longitudinal axis of the interconnection shaft member 66.

The cartridge support anchor component 62 is hollow and has an outer peripheral wall 74.

An opening end of the outer peripheral wall 74 of the cartridge support anchor component 62 is connected or attached to the common wall 59 about the common wall opening 60 in liquid (i.e. water) tight fashion so as to inhibit leaks thereabout (e.g. by a suitable weld 76 in the case where both the common wall and the peripheral wall are of metal). Liquid medium in the inlet chamber thus has access to the interior of the cartridge support anchor component 62, defined by the outer peripheral wall 74, through the common wall opening 60.

The other end of the cartridge support anchor component is provided with an annular gasket engagement platform 77; this platform has a central opening 77a. The annular gasket engagement platform 77 is disposed so as to engage an annular gasket (e.g. rubber gasket) attached to a cartridge assembly of the present invention.

Referring to FIGS. 5, 6 and 7 these figures show two annular gaskets, namely upper and lower gaskets 78 and 80 (i.e. rubber gaskets) associated with respect to end cap element 9 or 11 of the cartridge assembly of FIGS. 1 to 8. The upper and lower gaskets 78 and 80 each have a pair of respective connection projections 82 or 83 which press fit engage with respective gasket engagement openings 84 or 86 of a respective end cap element 9 or 11. On the other hand, if two or more cartridge assemblies are to be stacked one upon the other only the bottom cartridge assembly need be provided with two such attached annular gaskets 78 and 80. As may be seen in FIG. 13 the upper cartridges need only be provided with the upper gasket 78 since the upper gasket 78 of an immediately adjacent lower cartridge assembly will serve the function of a lower gasket for the upper cartridge assembly.

Turning back to FIGS. 9 to 13, and in particular FIG. 13, a liquid permeable shaft connection member 90 is disposed in the interior of the cartridge support anchor component 62. One end of the shaft connection member 90 is attached to the interior side of the engagement platform 77 about the central opening 77a in liquid (i.e. water) tight fashion (e.g. by weld 92 where the platform 77 is of metal) so as to inhibit leaks. The other end of the shaft connection member 90 is provided with a socket member 94 having interior screw threads for screw engagement with the threaded end 68 of the interconnection shaft member 66 i.e. the interconnection shaft member 66 is (screw) attached to the cartridge support anchor component 62 by this socket member 94. The shaft connection member 90 is also provided between the two ends thereof with openings 98 such that liquid medium may pass into the interior of the shaft connection member 90 and out through the central opening 77a.

The cartridge attachment component has a rotatable compression adjustment member 100 which has an opening 102 for receiving the other end 70 of the interconnection shaft member 66. The opening 102 of the rotatable compression adjustment member is provided with interior screw threads for screw engagement with the screw threads of the end 70 of the interconnection shaft member 66.

The cartridge attachment component includes a compression spring 104 disposed about the interconnection shaft member 66 between the rotatable compression adjustment member 100 and a compression engagement member 106.

The compression engagement member 106 has an opening through which the interconnection shaft member 66 may pass for engagement with the compression adjustment member 100. The compression engagement member 106 has an annular shoulder member 108 for (compression) engagement with the upper annular gasket 78 attached to the immediately adjacent cartridge assembly.

The cartridge attachment component also has a sleeve member 110 and a washer member 112 which are rotatable about the longitudinal axis of the interconnection shaft member 66.

As may be appreciated the direction of rotation of the compression adjustment member 100 will determine the degree of compression to which the cartridge assembly(ies) are subjected; during operation sufficient compression is to be applied so as to provide liquid (i.e. water) tight interconnection between adjacent cartridge assemblies and between the cartridge assembly(ies) and the adjacent cartridge support anchor component and the adjacent cartridge attachment component. Referring to FIG. 13 rotation of the compression adjustment member which induces displacement of the compression adjustment member in the direction of the arrow 114 will favor compression whereas an opposite rotation which induces displacement of the compression adjustment member in the direction of the arrow 116 will release compression and at the limit allow removal of the compression adjustment member altogether from the interconnection shaft member 66 such that the stacked cartridge assemblies may be removed for replacement. If desired the removed, used cartridge assemblies may be broken down in order to replace the particulate charge. Thus by removing one or both of the releasable end cap elements, and if necessary or desired detaching the wall panels one from other, the used particulate charge may be recovered; thereafter the components of the cartridge assembly as necessary or desired may be cleaned and the cartridge assembly refilled (for example in the manner as mentioned above) with new particulate material.

As may be seen in FIGS. 12 and 13 the cartridge assemblies 1 are shown charged with solid (e.g. particulate) material 118.

Liquid (medium) may pass through the cartridge tower of FIGS. 12 and 13 as shown by the flow arrows 120.

FIG. 14 illustrates in schematic fashion the association of a cartridge assembly of the present invention as part of a cartridge tower 121 in a separator system for the separation of an (immiscible) oil from water. The cartridge tower 121 may comprise for example, a cartridge tower such as shown in FIGS. 11 to 13, i.e. be a cartridge tower with three (particle material) charged cartridge assemblies of the present invention. A cartridge tower could, of course, as desired or necessary comprise a different number of charged cartridge assemblies, i.e. one or more charged cartridge assemblies. Furthermore, although FIG. 1 shows a single cartridge tower 121, a separator system may comprise a plurality of cartridge towers, i.e. one or more cartridge towers (see FIGS. 9 and 10 for example). Although not shown the cartridge tower may, as desired or necessary, be associated with a tower stabilization/alignment means, e.g. a support ring connected to the separator housing which has an opening which is sized to just be able to encircle but not to touch the outer diameter surface of the last upper cartridge assembly; the support opening sized would allow a cartridge assembly to pass axially therethrough.

The system shown in FIG. 14 has a lower liquid input chamber 122 with a liquid inlet 124 and an upper separation chamber 126 with an upper liquid outlet 128 and a lower liquid outlet 130. For the single cartridge tower shown the lower liquid input chamber 122 and the liquid inlet 124 could of course be combined as a single inlet pipe arrangement. The lower liquid chamber is shown as a possible arrangement for including a plurality of cartridge towers each being suitably connected to the common wall 59; alternatively each cartridge support anchor component 62 may be connected to an independent inlet pipe instead of to the common wall 59 or even to a separate distinct liquid input chamber with its own common wall. The liquid combination water/oil enters the lower input chamber as shown by arrow 132. The liquid combination then proceeds upwardly through the cartridge support as shown by the arrow 134. Once passing into the cartridge tower comprising one or more cartridge assemblies of the present invention the separated water passes out of the cartridge tower as shown by arrows 136 and the oil passes out of the tower as shown by dotted arrows 138. The water then passes out of the separator as shown by arrow 140 and the lighter (immiscible) oil passes out of the separator by the arrow 142.

1. A fluid treatment cartridge assembly for holding solid material defining a fluid permeable body for contact with a fluid, said cartridge assembly comprising:
an outer cylindrical housing component having a first cylindrical axis and
an inner tubular component disposed within said cylindrical housing component,
said outer cylindrical housing component comprising a first cap element, a second cap element and a cylindrical enclosure wall element, said cylindrical enclosure wall element terminating in opposed ends, one of said opposed ends being closed off by said first cap element and the other opposed end being closed off by said second cap element,
said inner tubular component having a first end member, a second end member and a tubular wall member extending from said first end member to said second end member, said inner tubular component defining an interior channel, said tubular wall member being fluid-permeable, and
wherein said outer cylindrical housing component and said inner tubular component define a holding chamber therebetween for holding said solid material,
wherein said first cap defines a first opening extending therethrough, the first end member of said inner tubular component being connected to said first cap element such that said first opening is in fluid communication with said interior channel of said inner tubular component,
wherein said cylindrical enclosure wall element comprises a plurality of interconnected wall panels, each of said wall panels extending from one said opposed end to the other said opposed end of said cylindrical enclosure wall element, at least one of said wall panels being fluid permeable,
wherein each wall panel is provided with a first slider interlock element and an opposed second slider interlock element, said first and second slider interlock elements being disposed and configured such that adjacent wall panels are slide interlocked by respective first and second slider interlock elements.

2. A fluid treatment cartridge assembly as defined in claim 1 wherein said inner tubular component has a tubular axis coterminous with said cylindrical axis and the second end of said tubular wall member second is connected to said second cap element.

3. A fluid treatment cartridge assembly as defined in claim 1 wherein said second cap element defines a second opening extending therethrough, the second end member of said inner tubular component being connected to said second cap element such that said interior channel of said inner tubular component is in fluid communication with said second opening.

4. A fluid treatment cartridge assembly as defined in claim 1 wherein said first end cap and said second end cap are each releasably connected to said cylindrical enclosure wall element and to said inner tubular component by respective releasable connection means.

5. A fluid treatment cartridge assembly as defined in claim 1 wherein each of said opposed ends of said cylindrical enclosure wall element comprises a first snap lock component and said first and second caps each comprise a respective second snap lock component, and wherein each first snap lock component and a respective second snap lock component are configured such that said first and second cap elements are interlocked thereby to a respective opposed end of said cylindrical enclosure wall element.

6. A fluid treatment cartridge assembly as defined in claim 5 wherein each of said second snap lock components comprises a plurality of respective resilient snap lock male members and each of said first snap lock components comprises a plurality of lock sockets for receiving a respective resilient snap lock male member.

7. A fluid treatment cartridge assembly as defined in claim 5 wherein said first and second snap lock components are each configured such that said first and second cap elements are releasably interlocked thereby to a respective opposed end of said cylindrical enclosure wall element.

8. A fluid treatment cartridge assembly as defined in claim 1 wherein each wall panel is a foraminous wall panel and said tubular wall member is a foraminous tubular wall member.

9. A fluid treatment cartridge assembly as defined in claim 1 wherein for each of said wall panels one of said slider interlock elements comprises a straight side edge male projection member and the other of said slider interlock elements comprises a straight side edge female slot member parallel to said straight side edge male projection member, said straight side edge male projection member and said straight side edge female slot member being disposed and configured such that adjacent wall panels have been interconnected by sliding the straight side edge male projection member of one wall panel in the straight side edge female slot member of an adjacent wall panel.

10. A fluid treatment cartridge assembly as defined in claim 9 wherein said straight side edge male projection member and said straight side edge female slot member are disposed parallel to said first cylindrical axis.

11. A wall panel for a cylindrical enclosure wall element of a cylindrical housing comprising a pair of end caps, said wall panel having opposed ends disposed transverse to first and second opposed slider interlock elements, said first slider interlock element being disposed parallel to said opposed second slider interlock element, said first and second slider interlock elements being disposed and configured such that adjacent wall panels are slide interlockeable by respective first and second slider interlock elements by sliding one slider interlock element in the other and wherein each of said opposed ends comprises a first snap lock element configured for interlocking with a respective second snap lock element of a respective cap.

12. A wall panel as defined in claim 11 wherein each of said second snap lock elements comprises a resilient snap lock male member and each of said first snap lock elements comprises a lock socket for receiving a respective resilient snap lock male member.

13. A wall panel as defined in claim 11 wherein the wall panel is a foraminous wall panel.

14. A wall panel as defined claim 11 wherein one of said slider interlock element comprises a straight side edge male projection member and the other slider interlock element comprises a straight side edge female slot member parallel to said straight side edge male projection member, said straight side edge male projection member and said straight side edge female slot member being disposed and configured such that the straight side edge male projection member of one wall panel is able to slide in the straight side edge female slot member of an adjacent wall panel so at to be able thereby to slide interconnect the adjacent wall panels.

15. A cylindrical enclosure wall comprising a plurality of slide interlocked wall panels as defined in claim 11.

16. A kit for creating a cylindrical enclosure wall comprising a plurality of slide interlocked wall panels, said kit comprising a plurality of wall panels as defined in claim 11.

17. A kit for creating a fluid treatment cartridge assembly for holding solid material defining a fluid permeable body for contact with a fluid, said kit comprising:
an inner tubular component for disposition within a cylindrical housing component having a first cylindrical axis, said inner tubular component having a first end member, a second end member and a tubular wall member extending from said first end member to said second end member, said inner tubular component defining an interior channel, said tubular wall member being fluid permeable,
a plurality of interconnectable wall panels for defining a cylindrical enclosure wall element, at least one of said wall panels being fluid permeable,
a first cap element and a second cap element, for defining, along with said cylindrical enclosure wall element, said outer cylindrical housing component,
said inner tubular component, said wall panels, said first cap element and said second cap element being configured for forming a cartridge assembly, said cartridge assembly being an assembly
wherein said cylindrical enclosure wall element terminates in opposed ends, one of said opposed ends being closed off by said first cap element and the other opposed end being closed off by said second cap element,
wherein said outer cylindrical housing component and said inner tubular component define a holding chamber therebetween for holding said solid material
wherein said first cap defines a first opening extending therethrough, the first end member of said inner tubular component being connectable to said first cap element such that said first opening is in liquid communication with said interior channel of said inner tubular component
wherein each of said wall panels is able to extend from one said opposed end to the other said opposed end of said cylindrical enclosure wall element, and
wherein each wall panel is provided with a first slider interlock element and an opposed second slider interlock element, said first and second slider interlock elements being disposed and configured such that adjacent wall panels are slide interlockable by respective first and second slider interlock elements.

18. A kit as defined in claim 17 wherein for each of said wall panels one of said slider interlock elements comprises a straight side edge male projection member and the other slider interlock element comprises a straight side edge female slot member parallel to said straight side edge male projection member, said straight side edge male projection member and said straight side edge female slot member being disposed and configured such that the straight side edge male projection member of one wall panel is able to slide in the straight side edge female slot member of an adjacent wall panel so at to be able thereby to interconnect the adjacent panels.

19. A kit as defined in claim 18 wherein said straight side edge male projection member and said straight side edge female slot member are disposed parallel to said first cylindrical axis.

20. A kit as defined in claim 17 wherein each wall panel is a foramina's wall panel and said tubular wall member is a foraminous tubular wall member.

21. A separator system for the separation of a water immiscible liquid from a liquid medium comprising water and the water immiscible liquid wherein water is the continuous phase, the system comprising at least one cartridge tower for the separation of said water immiscible liquid from the liquid medium, the cartridge tower comprising one or more cartridge assemblies and clamp type cartridge attachment means for connecting each of said cartridge assemblies to liquid medium inlet means so that each of said cartridge assemblies are in liquid communication with said liquid medium inlet means, each of said cartridge assemblies being charged with a predetermined particulate material defining a liquid permeable coalescent body, said cartridge assemblies each being a cartridge assembly as defined in claim 1, said liquid medium inlet means being in liquid communication with the interior channel of the inner tubular component of said cartridge assemblies.

22. A fluid treatment cartridge assembly for holding solid material defining a fluid permeable body for contact with a fluid, said cartridge assembly comprising:
an outer cylindrical housing component having a first cylindrical axis and an inner tubular component disposed within said cylindrical housing component,
said outer cylindrical housing component comprising a first cap element, a second cap element and a cylindrical enclosure wall element, said cylindrical enclosure wall element terminating in opposed ends, one of said opposed ends being closed off by said first cap element and the other opposed end being closed off by said second cap element,
said inner tubular component having a first end member, a second end member and a tubular wall member extending from said first end member to said second end member, said inner tubular component defining an interior channel, said tubular wall member being fluid-permeable, and
wherein said outer cylindrical housing component and said inner tubular component define a holding chamber therebetween for holding said solid material,
wherein said first cap defines a first opening extending therethrough, the first end member of said inner tubular component being connected to said first cap element such that said first opening is in fluid communication with said interior channel of said inner tubular component,
wherein said cylindrical enclosure wall element comprises a plurality of interconnected wall panels, each of said wall panels extending from one said opposed end to the other said opposed end of said cylindrical enclosure wall element, at least one of said wall panels being fluid permeable, each wall panel being provided with respective wall interconnect means whereby adjacent wall panels are releasably interlocked.

23. A fluid treatment cartridge assembly as defined in claim 22 wherein said inner tubular component has a tubular axis coterminous with said cylindrical axis and the second end of said tubular wall member second is connected to said second cap element.

24. A fluid treatment cartridge assembly as defined in claim 22 wherein said second cap element defines a second opening extending therethrough, the second end member of said inner tubular component being connected to said second cap element such that said interior channel of said inner tubular component is in fluid communication with said second opening.

25. A fluid treatment cartridge assembly as defined in claim 22 wherein said first end cap and said second end cap are each releasably connected to said cylindrical enclosure wall element and to said inner tubular component by respective releasable connection means.

26. A fluid treatment cartridge assembly as defined in claim 22 wherein each of said opposed ends of said cylindrical enclosure wall element comprises a first snap lock component and said first and second caps each comprise a respective second snap lock component, and wherein each first snap lock component and a respective second snap lock component are configured such that said first and second cap elements are interlocked thereby to a respective opposed end of said cylindrical enclosure wall element.

27. A fluid treatment cartridge assembly as defined in claim 26 wherein each of said second snap lock components comprises a plurality of respective resilient snap lock male members and each of said first snap lock components comprises a plurality of lock sockets for receiving a respective resilient snap lock male member.

28. A fluid treatment cartridge assembly as defined in claim 26 wherein said first and second snap lock components are each configured such that said first and second cap elements are releasably interlocked thereby to a respective opposed end of said cylindrical enclosure wall element.

29. A fluid treatment cartridge assembly as defined in claim 22 wherein each wall panel is a foraminous wall panel and said tubular wall member is a foraminous tubular wall member.

30. A separator system for the separation of a water immiscible liquid from a liquid medium comprising water and the water immiscible liquid wherein water is the continuous phase, the system comprising at least one cartridge tower for the separation of said water immiscible liquid from the liquid medium, the cartridge tower comprising one or more cartridge assemblies and clamp type cartridge attachment means for connecting each of said cartridge assemblies to liquid medium inlet means so that each of said cartridge assemblies are in liquid communication with said liquid medium inlet means, each of said cartridge assemblies being charged with a predetermined particulate material defining a liquid permeable coalescent body, said cartridge assemblies each being a cartridge assembly as defined in claim 22, said liquid medium inlet means being in liquid communication with the interior channel of the inner tubular component of said cartridge assemblies.
